(19) United States
(12) Patent Application Publication
(10) Pub. No.: US 2023/0256671 A1
(43) Pub. Date: Aug. 17, 2023

(54) PRINTING DEVICE

(71) Applicant: KRAUSSMAFFEI TECHNOLOGIES GMBH, München (DE)

(72) Inventor: Jochen ZWIESELE, München (DE)

(21) Appl. No.: 18/001,810

(22) PCT Filed: May 12, 2021
(86) PCT No.: PCT/EP2021/062576

§ 371 Date: Apr. 28, 2023

(30) Foreign Application Priority Data
Jul. 22, 2020 (DE) 10 2020 119 354.8

(51) Int. Cl. B29C 64/209; B29C 64/118; B29C 64/393; B33Y 30/00; B33Y 10/00

(52) U.S. Cl. CPC B29C 64/209; B29C 64/118; B29C 64/393; B33Y 30/00; B33Y 10/00

(57) ABSTRACT

The application relates to a device for depositing a melted material, such as a plastic material, on a surface, in particular a printhead for a 3D printer, including a housing, a discharge nozzle arranged on the housing, and a metering device with a first metering unit and a second metering unit, each of which is designed to receive the melted material and dispense same in a metered manner, wherein the metering device is designed to supply the melted material to the discharge nozzle, in particular an outlet channel of the discharge nozzle, by means of the first metering unit and the second metering unit in an alternating manner or on-the-fly. The application also relates to a printing device, in particular a 3D printing device, such as a 3D printer, and to a method for depositing a material, in particular in a 3D printing method or an additive manufacturing method.

### CROSS-REFERENCE TO RELATED APPLICATIONS

This application is a U.S. National Stage entry of PCT/EP2021/062576, filed May 12, 2021, which claims benefit of priority to German application 10 2020 119 354.8, filed Jul. 22, 2020, the entire disclosures of which are hereby incorporated herein by reference.

### FIELD OF INVENTION

The invention relates to a printing device, in particular a 3D printing device, such as a 3D printer, with an extrusion device for melting a material, such as plastic material, and with a 3D printhead for depositing the material melted by the extrusion device, such as plastic material, onto a surface, such as a working surface, comprising a housing and a discharge nozzle arranged on the housing.

3D printers usually comprise a printhead, in which a starting material is prepared in a print-ready manner. To generate a relative movement between the printhead and the working surface on which the object or respectively component is to be created, means or respectively kinematic arrangements, such as for instance 3-axis systems or robot arrangements, are provided. Here, either only the printhead, only the working surface or both the printhead and also the working surface can be moved.

The widespread method is “Fused Deposition Modelling” (FDM), in which a filament of the starting material is melted in a nozzle and is applied in a layered manner onto a working surface. Usually, filaments with a constant diameter, e.g. 1.76 mm, are used here. The filament is pressed through a heated nozzle with a constant diameter, e.g. 0.4 mm. A discharge of a melt stream can be defined by means of a regulated speed of advance of the filament. Mostly, the printhead is moved in a targeted manner on a structure which is movable in three axes, in order to produce the printed component by a defined deposit of the melt stream. In contrast to other methods, components are created here in a free-formed manner and are not surrounded by unconsolidated material.

For example, U.S. Pat. No. 5,121,329 A discloses such a “Fused Deposition Modelling” method, in which a thermoplastic plastic wire is pressed through a heated nozzle and reproduces the individual layers of the component on the working surface by moving the working surface and/or the nozzle. The second and all further layers are printed here onto the structure lying therebeneath.

However, owing to the melting behaviour of the plastics, this method is not scalable for high diameters and is therefore not suitable for large or respectively large-volume components.

For large components, for example extruders are attached to industrial robots and are guided over the working surface in order to print the component. DE 10 2014 018 081 A1 discloses, for example, a system for additive manufacture, with an extruder device arranged on a three-dimensionally movable kinematic arrangement, which extruder device is moved for depositing the extruded material thread over a build platform.

It is disadvantageous here that the extruder, and thus large masses or respectively weights, have to be moved. As the conveying rate in extruders depends on the counter-pressure, a precise melt discharge can not be guaranteed in a system without substantial counter-pressure, or through the influence of the nozzle diameter. Likewise, a rapid regulation of the throughput can not take place by means of the extruder rotation rate. It is thus not possible to discharge greater volume streams with stable melt quality and to guarantee a high printing accuracy with a flexible melt stream control.

### SUMMARY OF THE INVENTION

The invention is based on the problem of structurally and/or functionally improving a printing device mentioned in the introduction.

It is therefore an object of the present invention to provide a printing device which reduces or respectively eliminates the problems indicated in connection with the prior art.

The problem is solved by a printing device, in particular a 3D printing device, such as a 3D printer, having the features of claim 1. Advantageous embodiments and/or further developments of the invention are the subject of the subclaims.

The printing device has an extrusion device for melting a material, such as plastic material, and a 3D printhead for depositing the material melted by the extrusion device onto a surface. The 3D printhead comprises a housing and a discharge nozzle arranged on the housing. The device for depositing a melted material can be for a 3D printer or a system for additive manufacture or arranged therein. The material can be a plastic material. The surface can be a working surface or a build platform. The surface can be arranged substantially horizontally. The surface can be part of the 3D printer or of the system for additive manufacture.

The 3D printhead has a metering device. The metering device has a first metering unit and a second metering unit. The first metering unit and the second metering unit are designed respectively for the receiving and/or the metered dispensing of the melted material. The metering device is designed to supply the melted material in an alternating manner or on-the-fly through the first metering unit and the second metering unit to an outlet channel of the discharge nozzle. Whilst therefore a conveying or respectively supplying of the melted material takes place from the one metering unit to the discharge nozzle or respectively its outlet channel, the other metering unit itself is filled with melted material. As soon as the melted material has been supplied from the one metering unit entirely or substantially entirely to the discharge nozzle or respectively its outlet channel, a switchover can be carried out, so that with the previously filled other metering unit a conveying or respectively supplying of the melted material takes place from this metering unit, in particular to the discharge nozzle or respectively its outlet channel, and the emptied one metering unit is filled again with melted material.

The metering units can be configured in a spatially compact manner, which on the one hand permits a flexible positioning of the metering units and on the other hand prevents a greater quantity of the melted material from remaining in one of the metering units over a longer period of time, which could lead to an impairment of the quality of the melted material.

The printing device can have a first operating state, in which fluid or melted material exits from the 3D printhead of the printing device, in particular from the discharge nozzle of the 3D printhead. The printing device can have a second operating state, in which no fluid or melted material exits from the 3D printhead of the printing device, in particular from the discharge nozzle of the 3D printhead. For example, the second operating state can be taken up when another position on the surface is to be approached and on the way towards it no material is to be placed down or deposited. A switchover can be made between the two operating states. For this, a control arrangement can be provided. For example, the advancing of the material can be switched on or respectively switched off, or released or respectively interrupted.

The 3D printhead and/or the discharge nozzle can comprise an inlet channel for introducing the melted material through the extrusion device. The inlet channel can be designed for connection to an outlet of the extrusion device and/or to an outlet of a hose element.

The metering arrangement can comprise a valve. The valve can be a switchover valve. The metering arrangement can comprise one or more valves. The valve can serve for switching over between the first metering unit and the second metering unit. The valve can be designed to switch over between a first position and a second position or respectively to be switched into the first position and the second position. The valve can be switched to and fro in an alternating manner between two positions. The positions can also be operating states, in particular of the valve or of the metering arrangement, or can define these. The device or the metering device can comprise a control arrangement for controlling the valve. The control arrangement can be designed to switch the valve in an alternating manner into the first position and into the second position. The valve is designed so that the melted material can be supplied to a metering unit and, at the same time, the other material unit can deliver melted material.

The valve can be designed to enable, in the first position, an entry of the melted material into the first metering unit. The valve can be designed, in the first position, to prevent an entry of the melted material into the second metering unit. The valve can be designed to enable and/or to prevent a filling of the first or respectively second metering unit with melted material.

The valve can be designed, in the second position, to enable an entry of the melted material into the second metering unit. The valve can be designed, in the second position, to prevent an entry of the melted material into the first metering unit.

The valve can be designed, in the first position, to enable a metered supplying of the melted material through the second metering unit to the discharge nozzle. The valve can be designed, in the first position, to prevent a supplying, in particular a metered supplying, of the melted material through the first metering unit to the discharge nozzle. The valve can be designed to enable and/or to prevent the discharging of melted material by means of the discharge nozzle.

The valve can be designed, in the second position, to enable a metered supplying of the melted material through the first metering unit to the discharge nozzle. The valve can be designed, in the second position, to prevent a supplying, in particular a metered supplying, of the melted material through the second metering unit to the discharge nozzle.

By means of the valve therefore a switchover can be carried out between a charging/filling of the metering units and a discharging of the melted material.

The first metering unit and the second metering unit have respectively a metering piston with a drive. The two metering pistons can be configured as double pistons. The metering pistons can be operated in tandem operation. The first metering unit and the second metering unit can have respectively a cylinder, in which the respective metering piston is arranged in an effective manner. The cylinders can serve as receiving containers for the melted material. The drive can be a drive with spindle and motor, a hydraulic drive, a pneumatic drive or an electric drive. The drive can be a drive with spindle and nut and with a motor. The motor can be an electric motor, servo motor or variable-speed motor. This permits the melted material to be dispensed in exact dosage from the metering units. In particular, in this way a good implementability and a good controllability can be achieved. The metering units can also be provided with other electronic drives suitable for this, or also with hydraulic or pneumatic drives for issuing the mixing components. The metering pistons can be controlled by means of a control arrangement. The metering pistons can have a regulated speed of advance, in particular by means of the control arrangement. Through the regulating of the advance of the metering pistons, an exact volume flow with little compression volume can be achieved. Additionally or alternatively, the upwards movement of the metering pistons can be regulated. Thereby, a constant charging pressure or filling pressure and hence a stable melt quality can be ensured, in particular at the extruder end.

The metering arrangement can be at least partially integrated in the discharge nozzle. The metering arrangement can be integrated entirely in the discharge nozzle. The first and/or second metering unit can be at least partially integrated in the discharge nozzle and/or arranged therein. The first and/or second metering unit can be integrated entirely in the discharge nozzle and/or arranged therein. The valve can be at least partially integrated in the discharge nozzle and/or arranged therein. The valve can be integrated entirely in the discharge nozzle and/or arranged therein.

The discharge nozzle can itself be produced by means of a 3D printing method or respectively additive production method. The discharge nozzle can be produced from plastic or metal.

The discharge nozzle can have a first channel for supplying the melted material from the first metering unit to the outlet channel. The discharge nozzle can have a second channel for supplying the melted material from the second metering unit to the outlet channel. The first channel and/or the second channel can open out, in particular on the discharge side, into a supply line, such as a supply channel. The supply line can open out, in particular on the discharge side, into the outlet channel. The first channel and/or the second channel can run in a straight or bent manner through the discharge nozzle.

The valve can be designed, in the first position, to interrupt the supply line between the first channel and the outlet channel. The valve can be designed, in the first position, to open the supply line between the second channel and the outlet channel.

The valve can be designed, in the second position, to interrupt the supply line between the second channel and the outlet channel. The valve can be designed, in the second position, to open the supply line between the first channel and the outlet channel.

For opening and closing the first or respectively second channel, the valve can have a first valve element, such as a valve tappet or valve pintle. The valve pintle can have a pin which can close the first or respectively second channel, in particular in cross-section. The first valve element and/or the pin can serve or be configured as a deflection element for deflecting the melted material into the outlet channel. The first valve element can be rotatable.

The discharge nozzle can have a third channel for supplying the melted material from the inlet channel to the first metering unit. The discharge nozzle can have a fourth channel for supplying the melted material from the inlet channel to the second metering unit. The third channel and/or the fourth channel can open out, particularly at the entry side, into the inlet channel. The first and the third channel can be connected with one another and/or can open out into the first metering unit, in particular into the cylinder of the first metering unit. The second and the fourth channel can be connected with one another and/or can open out into the second metering unit, in particular into the cylinder of the second metering unit. At the respective connection point, the first or respectively second metering unit can be arranged in an effective manner.

The valve can be designed, in the first position, to open the supply line between the inlet channel and the third channel. The valve can be designed, in the first position, to open the feed line between the inlet channel and the third channel. The valve can be designed, in the first position, to interrupt the supply line between the inlet channel and the fourth channel.

The valve can be designed, in the second position, to open the supply line between the inlet channel and the fourth channel. The valve can be designed, in the second position, to interrupt the supply line between the inlet channel and the third channel.

For opening and closing the third or respectively fourth channel, the valve can have a second valve element, such as a valve cylinder, valve tappet or valve pintle. The second valve element can have one or more bores or recesses. The second valve element can serve or be designed as a deflection element for deflecting the melted material into the third or respectively fourth channel. The second valve element can be rotatable.

The discharge nozzle can be arranged in an interchangeable manner on the housing. The discharge nozzle can be designed as an exchangeable insert. The discharge nozzle can be detachably connected to the housing. The discharge nozzle can be screwed or clamped to the housing or plugged at it or thereon.

The device and/or the discharge nozzle can have a heating arrangement and/or a cooling arrangement for controlling the temperature of the melted material.

The extrusion device can be an extruder, a screw extruder, a single-screw extruder, a twin-screw extruder, a multi-screw extruder, a co-rotating or counter-rotating twin-screw extruder, a compounder or an injection moulding compounder. The extrusion device can have at least one extruder screw. The at least one extruder screw can have screw elements or screw sections for conveying, mixing and/or plasticizing/melting the material.

The printing device can have the surface, such as working surface or build platform. The surface can be arranged substantially horizontally.

The extrusion device can have an inlet and an outlet. The at least one extruder screw can be designed to convey the material from the inlet to the outlet. The inlet can be funnel-shaped or can be a funnel. The outlet can be designed in a nozzle-like manner. The outlet can be an outlet channel. The outlet can be an extrusion tool or an extrusion mould. The outlet can be connected to the device for depositing the melted material onto the surface or can be designed to be connected therewith. The device/printhead can be connected directly, i.e. without intermediate piece, with the outlet of the extrusion device. The inlet channel of the device/printhead can be connected directly with the outlet of the extrusion device. The outlet of the extrusion device can open out into the inlet channel.

The printing device can have a hose element for supplying the melted material from the outlet of the extrusion device to the inlet of the 3D printhead. The hose element can be designed as a flexible or elastic hose. The hose element can be produced from plastic, for example, polytetrafluoroethylene, such as Teflon. The hose element can be connected by its one end with the outlet, in particular with the outlet channel, of the extrusion device, and by its other end with the inlet, in particular with the inlet channel of the 3D printhead for depositing the melted material onto the surface. The hose element can have a heating arrangement for controlling the temperature of the melted material. The heating arrangement can have one or more heating sleeves. The heating arrangement can at least partially surround the hose element and/or be fastened on the hose element. The heating arrangement can be designed so as to be flexible or elastic.

At the outlet of the extrusion device and/or at the inlet of the 3D printhead for depositing the melted material onto the surface, a pressure sensor can be arranged in an effective manner. The pressure sensor can serve to detect the melt pressure or be designed for this.

The printing device can have a movement device. The movement device can have a two- or three-dimensionally movable kinematic arrangement, such as a 3-axis system. The movement device can have a robot arm or a robot, such as an industrial robot. The robot can have three or more axes, for example six or eight axes.

The 3D printhead for depositing the melted material onto the surface can be arranged on the movement device. This has the advantage that the 3D printhead can be positioned flexibly and free-formed components can be easily produced. The extrusion device can be designed to be stationary. This means that the extrusion device can be fixedly placed at a location during operation. Alternatively, the extrusion device can be arranged on the movement device. By means of the movement device, the 3D printhead and/or the extrusion device can be guided over the surface and/or the component.

The printing device can serve for the producing of large-volume or respectively large components.

A further aspect relates to the use of the device, described above and/or below, for the depositing of the melted material onto the surface or respectively of the printhead in a 3D printing method or respectively additive manufacturing method.

A further aspect relates to the use of the printing device, described above and/or below, in a 3D printing method or respectively additive manufacturing method.

A further aspect relates to a method for the depositing of a material, in particular in a 3D printing method or additive production method, such as for example the fused deposition modelling method, wherein the material is supplied from an extrusion device to a device for depositing the melted material, such as a printhead, and is applied by means of the device onto a surface, such as a working surface. The method can comprise the step: filling a first metering unit with melted material and metered dispensing of the melted material from a second metering unit. The method can comprise the step: depositing onto the surface the melted material which is dispensed in a metered manner.

To sum up and presented in other words, therefore through the invention inter alia a device is produced for depositing a melted material onto a surface, such as a printhead, and a printing device, such as a structure for a 3D printer. In particular, large-volume parts can be produced with the printhead and/or the printing device. A stationary extruder can be coupled to a heated hose. The hose can be coupled to the printhead. The printhead can have a nozzle, such as a discharge nozzle. The nozzle can have a defined diameter. The nozzle can be embodied as an exchangeable insert. The extruder can convey melt, such as plastic melt, via the heated hose to the printhead. The printhead can have two metering pistons, for example a double piston in tandem operation, or respectively two metering units. A metering piston can serve for the precise metering of the melt, for example of the melt filament. Meanwhile, the second metering piston or respectively metering unit can be charged or respectively filled with melt. The printhead can have a switchover valve. Via the switchover valve, a switching can be carried out between the two functions “charging” and “metering” of the metering pistons or respectively metering units. The switchover valve can be a central switchover valve. Via the central switchover valve therefore a switching over can take place between the charging/filling of a metering piston or respectively metering unit and the discharging of the melt. If a metering piston or respectively metering unit were to be charged or respectively filled earlier, the extruder can be switched off. Via a precisely regulated speed of advance of the metering piston, a very clean or respectively precise volume flow can be ensured with little compression volume by the regulating of the advance of the metering piston through the discharge nozzle. The metering piston can be operated via a variable-speed motor with a spindle. Within the path control, the volume flow can thus be adapted easily and dynamically. Via an upwards movement of the metering piston, a constant charging pressure or respectively filling pressure and hence a stable melt quality can be ensured at the extruder end. A pressure sensor can be arranged at the end of the extruder. When a metering piston or respectively metering unit is filled, the extruder can be switched off at least temporarily. Preferably, the extruder can be operated continuously. In particular in the case of very large components, the extruder can also be carried along on rough movements. The extruder can be arranged on a movement device, such as a robot or respectively industrial robot.

By the invention, large or respectively larger-volume components can be produced easily or respectively by means of a 3D printing method or additive manufacturing method. In particular, it is possible to discharge larger volume flows with stable melt quality. Furthermore, a high printing accuracy with flexible melt flow control can be ensured. A more precise melt discharge is made possible. A quick controllability of the throughput can be provided via the extruder rotation rate. The influence of the discharge nozzle diameter on the conveying pressure is prevented or greatly reduced. Compression effects are prevented or at least reduced. Furthermore, a lower weight is moved, which leads to a higher accuracy.

In case of need, a 3D printing nozzle can be additionally mounted onto the discharge nozzle, if a melt strand with a different geometry, in particular with a different cross-section, is desired for the 3D printing. In such a case, a 3D printing nozzle with a particular cross-section of the outlet opening of this 3D printing nozzle can be attached to the discharge nozzle. For example, the outlet opening of the 3D printing nozzle can have a rectangular or a polygon-like cross-section. As a result, melted plastic material can be directed out from the discharge nozzle into the 3D printing nozzle, and a melt strand with a cross-section corresponding to the outlet opening can be discharged from the 3D printing nozzle.

### BRIEF DESCRIPTION OF THE DRAWINGS

Example embodiments of the invention are described more closely below with reference to figures; here, there are shown schematically and by way of example:

FIG. 1 a front view of a 3D printhead;

FIG. 2 a perspective side view of the 3D printhead according to FIG. 1;

FIG. 3 a variant of a printing device with a 3D printhead according to FIG. 1; and

FIG. 4 a further variant of a printing device with a 3D printhead according to FIG. 1.

### DESCRIPTION OF EXAMPLE EMBODIMENTS

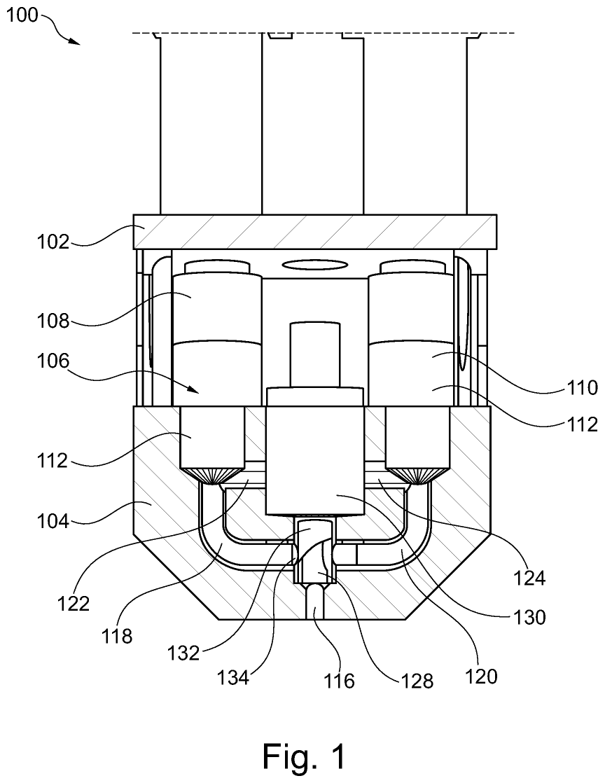

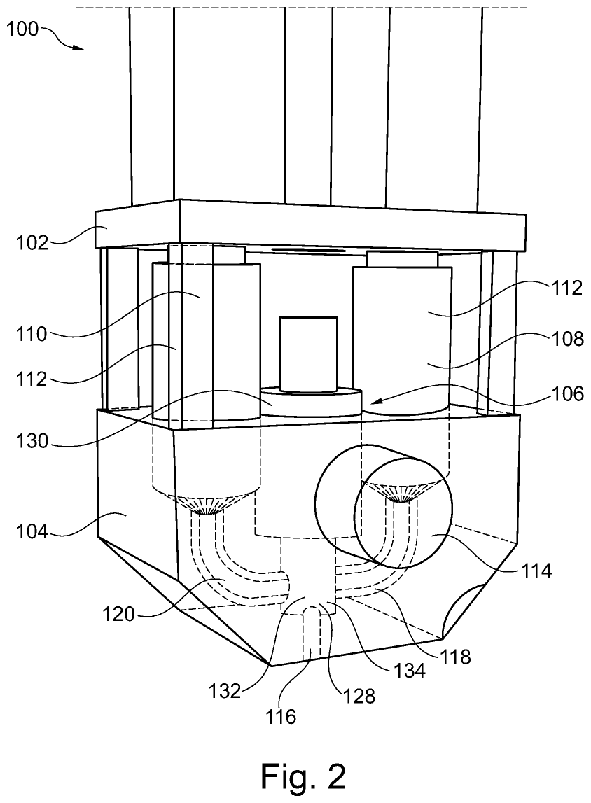

FIGS. 1 and 2 show a device 100 for depositing a melted plastic material onto a surface. The device 100 is designed as a 3D printhead 100. The 3D printhead 100 has a housing 102 and a discharge nozzle 104 detachably fastened to the housing. The discharge nozzle 104 is designed as an exchangeable insert. The 3D printhead 100 has a metering device 106 with a first metering unit 108 and a second metering unit 110, which are designed respectively for the receiving and metered delivering of the melted plastic material. The metering device 106 is partially integrated in the discharge nozzle 106. The metering device 106 is designed so that the melted plastic material can be supplied in an alternating manner or on-the-fly through the first metering unit 108 and the second metering unit 110 to the discharge nozzle 104. The first metering unit 108 and the second metering unit 110 have respectively a metering piston 112 with a drive.

As can be seen in FIGS. 1 and 2, the discharge nozzle 104 has an inlet channel 114 for introducing the melted plastic material, and an outlet channel 116.

The discharge nozzle 104 has a first channel 118 for supplying the melted plastic material from the first metering unit 108 to the outlet channel 116, and a second channel 120 for supplying the melted plastic material from the second metering unit 110 to the outlet channel 116. The discharge nozzle 104 has, furthermore, a third channel 122 for supplying the melted plastic material from the inlet channel 114 to the first metering unit 108, and a fourth channel 124 for supplying the melted plastic material from the inlet channel 114 to the second metering unit 110. The first channel 118 and the second channel 120 open out into a supply channel 128, which opens out into the outlet channel 116 of the discharge nozzle 104. The inlet channel 114 opens out into the third channel 122 and into the fourth channel 124.

The metering device 106 has a switchover valve 130 for switching over between the first metering unit 108 and the second metering unit 110 and between a first position and a second position. The switchover valve 130 is designed to enable, in the first position, an entry of the melted plastic material into the first metering unit 108, and to prevent an entry of the melted plastic material into the second metering unit 110, and at the same time to enable a metered supplying of the melted plastic material through the second metering unit 110 to the discharge nozzle 104, and to prevent a supplying through the first metering unit 108. Furthermore, the switchover valve 130 is designed, in the second position, to enable an entry of the melted plastic material into the second metering unit 110, and to prevent an entry of the melted plastic material into the first metering unit 108, and at the same time to enable a metered supplying of the melted plastic material through the first metering unit 108 to the discharge nozzle 104, and to prevent a supplying through the second metering unit 110.

The switchover valve 130 has a first valve element 132, designed as a valve pintle, for opening and closing the first channel 118 or respectively the second channel 120. The valve pintle 132 is arranged in an effective manner in the supply channel 128 and has a pintle 134, which can close the first or respectively second channel 118, 120 in cross-section. The valve pintle 132 is furthermore designed as a deflection element for deflecting the melted plastic material into the outlet channel 116.

For opening and closing the third channel 122 or respectively the fourth channel 124, the switchover valve 130 has a second valve element 136, which is designed as a deflection element for deflecting the melted plastic material from the inlet channel 114 into the third or respectively fourth channel 122, 124. The second valve element 136 is arranged in an effective manner between the inlet channel 114 and the third and fourth channel 122, 124.

The switchover valve 130 is designed, in the first position, to interrupt the supply line between the first channel 118 and the outlet channel 116, and to open the supply line between the second channel 120 and the outlet channel 116 (cf. FIGS. 1 and 2), and at the same time to open the supply line between the inlet channel 114 and the third channel 122, and to interrupt the supply line between the inlet channel 114 and the fourth channel 124.

Furthermore, the switchover valve 130 is designed, in the second position, to interrupt the supply line between the second channel 120 and the outlet channel 116, and to open the supply line between the first channel 118 and the outlet channel 116, and at the same time to open the supply line between the inlet channel 114 and the fourth channel 124 and to interrupt the supply line between the inlet channel 114 and the third channel 122.

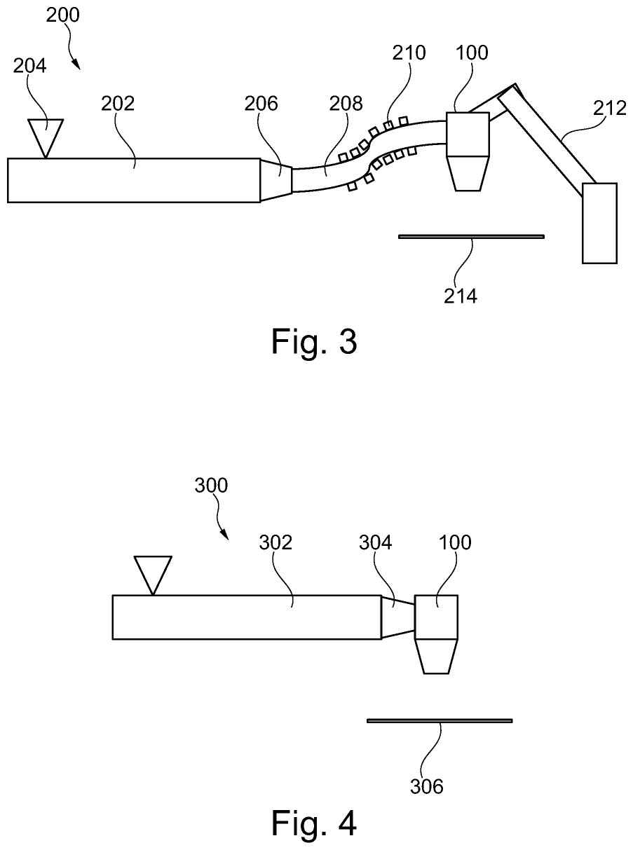

FIG. 3 shows a variant of a printing device 200 with a 3D printhead 100 according to FIG. 1. The printing device 200 is designed as a 3D printing device 200. The printing device 200 has an extrusion device 202, designed as an extruder 202, for the melting of plastic material. The extruder 202 is designed so as to be stationary, so that it remains at its place of installation during operation.

The extruder 202 has an inlet funnel 204 for the supplying of granular plastic material, an extruder screw for the plasticizing of the plastic material, and an extruder outlet 206. The extruder screw plasticizes the plastic material and conveys the plastic material from the inlet funnel 204 to the extruder outlet 206.

A flexible heated hose 208 is fastened to the extruder outlet 206, through which hose the extruded melted plastic material is pressed. A heating arrangement 210 for controlling the temperature of the melted plastic material flowing within the hose 208 is arranged around the hose 208.

By its other end, the hose 208 is connected to the inlet channel 114 of the 3D printhead 100. The melted plastic material can thus be supplied to the 3D printhead 100. The 3D printhead 100 is fastened to a movement arrangement 212, embodied as a robot 212. By means of the robot 212, the discharge nozzle 104 can be moved freely over a stationary working surface 214, in order to deposit melted plastic strands thereon and to manufacture a 3D-printed component.

Otherwise, reference is to be made additionally to FIGS. 1 and 2 and the associated description.

FIG. 4 shows a further variant of a printing device 300 with a 3D printhead 100 according to FIG. 1. In contrast to the variant according to FIG. 3, the 3D printhead 100 here is arranged directly on an extruder 302. An extruder outlet 304 is therefore connected directly to the inlet channel 114 of the 3D printhead 100.

The extruder 306 here can also be designed so as to be stationary at its place of installation. The 3D printhead 100 is therefore likewise stationary. In order to now be able to manufacture a 3D-printed component, the printing device 300 has a movable working surface 306. The working surface 306 can be moved for example in a horizontal plane. In addition, the working surface 306 can be moved in vertical direction.

Alternatively, the printing device 300 can have a movement arrangement on which both the extruder 302 and also the 3D printhead 100 are fastened, in order to move the discharge nozzle 116 of the 3D printhead 100 over a stationary working surface 306.

Otherwise, reference is to be made in addition in particular to FIGS. 1 to 3 and the associated description.

“Can” designates in particular optional features of the invention. Consequently, there are also further developments and/or embodiment examples of the invention which have additionally or alternatively the respective feature or the respective features.

If required, isolated features can also be singled out from the feature combinations disclosed here present, and can be used under resolution of a structural and/or functional context possibly existing between the features, in combination with other features for delimitation of the subject of the claim.

1.-24. (canceled)

25. A printing device, comprising a 3D printing device, with:
an extrusion device for melting a material, such as plastic material, and
a 3D printhead for depositing the material melted by the extrusion device onto a surface comprising a housing, and a discharge nozzle arranged on the housing, comprising a metering device with a first metering unit and a second metering unit, which are designed respectively for the receiving and metered dispensing of the melted material, wherein the metering device is designed to supply the melted material to an outlet channel of the discharge nozzle through the first metering unit and the second metering unit in an alternating manner or on-the-fly, and wherein the first metering unit and the second metering unit respectively has a metering piston with a drive.

26. The printing device according to claim 25, characterized in that the 3D printhead and/or the discharge nozzle has an inlet channel for introducing the melted material through the extrusion device.

27. The printing device according to claim 25, characterized in that the metering device has a valve, such as a switchover valve, for switching over between the first metering unit and the second metering unit and/or between a first position and a second position.

28. The printing device according to claim 27, characterized in that the valve is designed, in the first position, to enable an entry of the melted material into the first metering unit and to prevent an entry of the melted material into the second metering unit.

29. The printing device according claim 27, characterized in that the valve is designed, in the second position, to enable an entry of the melted material into the second metering unit and to prevent an entry of the melted material into the first metering unit.

30. The printing device according to claim 27, characterized in that the valve is designed, in the first position, to enable a metered supplying of the melted material through the second metering unit to the discharge nozzle, and to prevent a supplying through the first metering unit.

31. The printing device according to claim 27, characterized in that the valve is designed, in the second position, to enable a metered supplying of the melted material through the first metering unit to the discharge nozzle, and to prevent a supplying through the second metering unit.

32. The printing device according to claim 25, characterized in that the metering device is at least partially integrated in the discharge nozzle.

33. The device according to claim 25, characterized in that the discharge nozzle has a first channel for supplying the melted material from the first metering unit to the outlet channel and/or has a second channel for supplying the melted material from the second metering unit to the outlet channel.

34. The printing device according to claim 33, characterized in that the valve is designed, in the first position, to interrupt a supply line between the first channel and the outlet channel, and to open the supply line between the second channel and the outlet channel.

35. The printing device according to claim 33, characterized in that the valve is designed, in the second position, to interrupt a supply line between the second channel and the outlet channel, and to open the supply line between the first channel and the outlet channel.

36. The printing device according to claim 25, characterized in that the discharge nozzle has a third channel for supplying the melted material from the inlet channel to the first metering unit and/or has a fourth channel for supplying the melted material from the inlet channel to the second metering unit.

37. The printing device according to claim 36, characterized in that the valve is designed, in the first position, to open a supply line between the inlet channel and the third channel, and to interrupt the supply line between the inlet channel and the fourth channel.

38. The printing device according to claim 36, characterized in that the valve is designed, in the second position, to open a supply line between the inlet channel and the fourth channel, and to interrupt the supply line between the inlet channel and the third channel.

39. The printing device according to claim 25, characterized in that the discharge nozzle is arranged on the housing in an interchangeable manner, as an exchangeable insert.

40. The printing device according to claim 25, characterized in that the 3D printhead is directly connected to an outlet of the extrusion device.

41. The printing device according to claim 25, characterized in that the printing device has a hose element for supplying the melted material from an outlet of the extrusion device to an inlet of the 3D printhead.

42. The printing device according to claim 41, characterized in that the hose element has a heating arrangement for controlling the temperature of the melted material.

43. The printing device according to claim 25, characterized in that the 3D printhead is arranged on a movement device, such as a robot.

44. The printing device according to claim 25, characterized in that the extrusion device is designed so as to be stationary or is arranged on the movement device, such as a robot.
